(19) United States
(12) Patent Application Publication
(10) Pub. No.: US 2026/0269705 A1
(43) Pub. Date: Sep. 10, 2026

(54) POWER CONVERTER

(71) Applicant: Delta Electronics, Inc., Taoyuan City (TW)

(72) Inventors: Ke Sun, Shanghai (CN); Shaopeng Han, Shanghai (CN); Yanbing Xia, Shanghai (CN)

(21) Appl. No.: 19/560,781

(22) Filed: Mar. 9, 2026

(30) Foreign Application Priority Data
Mar. 10, 2025 (CN) 202510279021.X

(51) Int. Cl. H02M 1/00; H02M 3/155

(52) U.S. Cl. CPC H02M 1/0045; H02M 1/0067; H02M 3/155

(57) ABSTRACT

A power converter is provided. The power converter includes an input port, an output port and N conversion units. The power converter is configured to receive an input voltage through the input port and output an output voltage through the output port. Each conversion unit includes a sub input port, a sub output port and a maximum stress rating. The sub input port of each conversion unit is connected with the input port to receive the input voltage. The sub output port of each conversion unit is connected with the output port. The maximum stress rating is a maximum stress tolerable by any component within the corresponding conversion unit. When the input voltage of the input port is greater than the maximum stress rating of any one of the N conversion units, the sub input ports of the N conversion units are connected in series.

### CROSS-REFERENCE TO RELATED APPLICATION

This application claims the priority to China Patent Application No. 202510279021.X filed on March 10, 2025, the entirety of which is hereby incorporated by reference.

### FIELD OF THE INVENTION

The present disclosure relates to power conversion, and more particularly to a power converter.

### BACKGROUND OF THE INVENTION

With the continuous expansion of data center scale and the advancement of AI technologies, the power demand of each rack has increased significantly. To satisfy the power demand of the rack, server power supplies are being developed toward enhanced power, enhanced efficiency and reduced volume. Consequently, the range of the bus input voltage received by power converter is becoming more diversified. For example, various other voltage levels are adopted besides the conventional 48V bus voltage.

The input voltage range of the conventional power converter is narrow. This means a single power module cannot support multiple different input voltages simultaneously. To satisfy the demands of various input voltage levels, a flyback circuit can be employed in the power module. However, the efficiency of the flyback circuit fails to meet the requirements of the server power supplies. Namely, the conventional power converter cannot simultaneously achieve both high efficiency and a wide input voltage range.

Therefore, there is a need of providing a power converter to obviate the drawbacks encountered from the prior arts.

### SUMMARY OF THE INVENTION

The present disclosure provides a power converter. When the input voltage received by the input port of the power converter of the present disclosure is greater than the maximum stress rating of any one of the two conversion units, the sub input ports of the two conversion units are connected in series. Namely, the power converter determines the connection relationship of the conversion unit according to the comparison result between the input voltage of the input port and the maximum stress rating of the conversion unit. Consequently, each conversion unit can operate properly. Moreover, the power converter of the present disclosure can achieve both enhanced efficiency and enhanced input voltage range.

In accordance with an aspect of the present disclosure, a power converter is provided. The power converter includes an input port, an output port and N conversion units. The power converter is configured to receive an input voltage through the input port and output an output voltage through the output port. N is an integer greater than 1. Each of the N conversion units includes a sub input port, a sub output port and a maximum stress rating. The sub input port of each of the N conversion units is connected with the input port to receive the input voltage. The sub output port of each of the N conversion units is connected with the output port. The maximum stress rating is a maximum stress tolerable by any component within the corresponding conversion unit. When the input voltage of the input port is greater than the maximum stress rating of any one of the N conversion units, the sub input ports of the N conversion units are connected in series.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a power converter of the present disclosure;

FIG. 2A is a schematic circuit diagram illustrating the power converter of FIG. 1, wherein the sub input ports of the N conversion units of the power converter are connected in series; and

FIG. 2B is a schematic circuit diagram illustrating the power converter of FIG. 1, wherein the sub input ports of the N conversion units of the power converter are connected in parallel.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

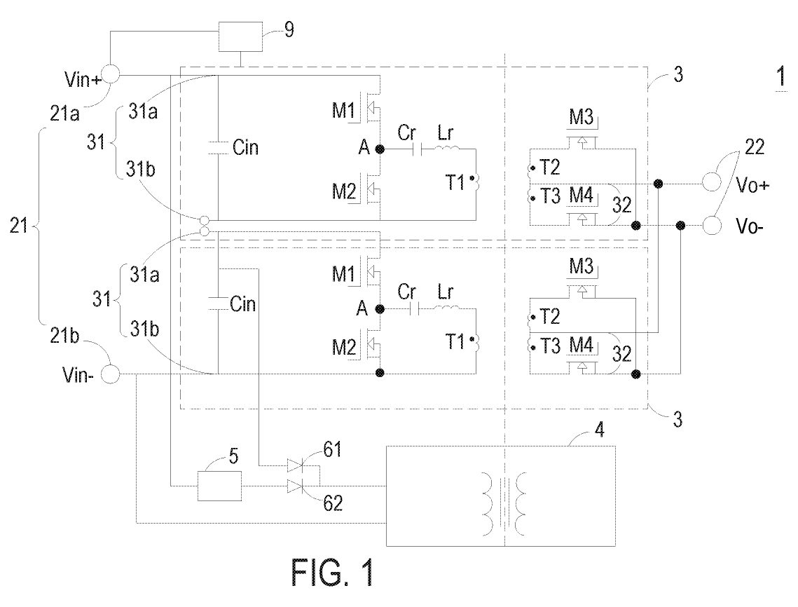

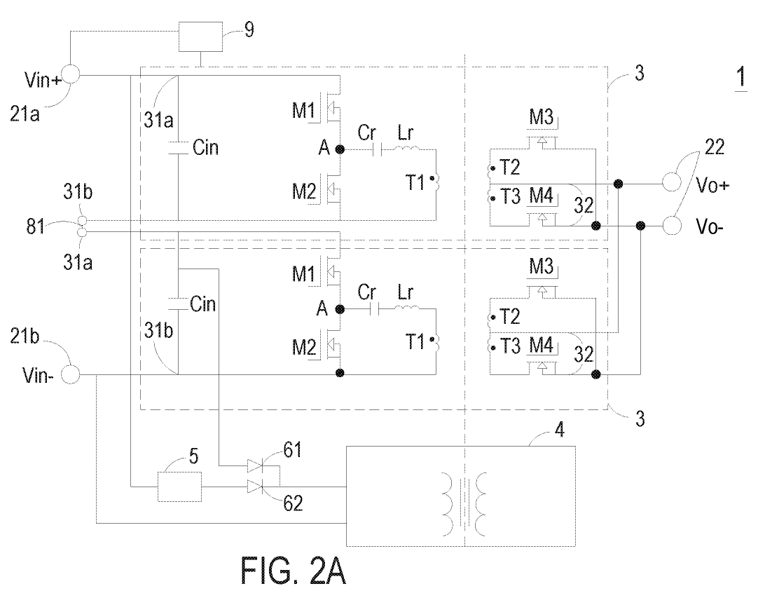

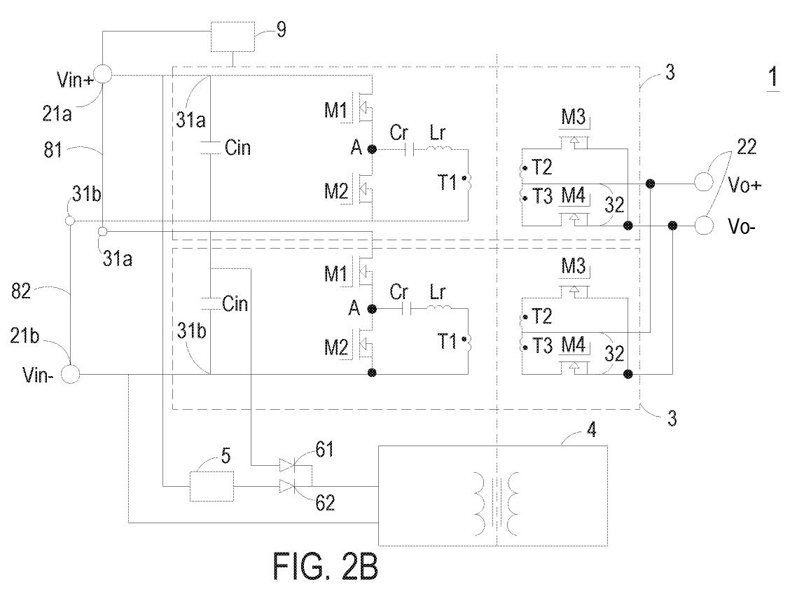

FIG. 1 is a schematic circuit diagram illustrating a power converter of the present disclosure. FIG. 2A is a schematic circuit diagram illustrating the power converter of FIG. 1, wherein the sub input ports of the N conversion units of the power converter are connected in series. FIG. 2B is a schematic circuit diagram illustrating the power converter of FIG. 1, wherein the sub input ports of the N conversion units of the power converter are connected in parallel. As shown in FIGS. 1, 2A and 2B, the power converter 1 of the present disclosure includes an input port 21, an output port 22, two conversion units 3 and at least one connection unit.

The power converter 1 receives an input voltage through the input port 21. The input port 21 includes a positive input terminal 21a and a negative input terminal 21b. The power converter 1 outputs an output voltage through the output port 22. In this embodiment, the power converter 1 includes two conversion units 3. Certainly, the number of the conversion units 3 may be adjusted according to specific requirements. Preferably but not exclusively, each conversion unit 3 is a resonant converter, a full-bridge circuit or a flyback circuit. Each conversion unit 3 includes a sub input port 31 and a sub output port 32. The sub input port 31 of each conversion unit 3 includes a sub positive input terminal 31a and a sub negative input terminal 31b. The sub positive input terminal 31a of the first conversion unit 3 of the two conversion units 3 is connected to the positive input terminal 21a of the input port 21 of the power converter 1. The sub negative input terminal 31b of the second conversion unit 3 of the two conversion units 3 is connected to the negative input terminal 21b of the input port 21 of the power converter 1. The sub output port 32 of each conversion unit 3 is connected to the output port 22 of the power converter 1. In this embodiment, the sub output ports 32 of the two conversion units 3 are connected with each other in parallel and connected to the output port 22 of the power converter 1. Each conversion unit 3 has a maximum stress rating. The maximum stress rating is the maximum stress tolerable by any one of the components within the corresponding conversion unit 3. The components of the conversion unit 3 will be described in further detail hereinafter.

When the input voltage received by the input port 21 is greater than the maximum stress rating of any one of the two conversion units 3, as shown in FIG. 2A, a first connection unit 81 is connected between the sub negative input terminal 31b of the sub input port 31 of the first conversion unit 3 and the sub positive input terminal 31a of the sub input port 31 of the second conversion unit 3. Consequently, the sub input terminals 31 of the two conversion units 3 are connected in series. In some embodiments, when the input voltage received by the input port 21 is less than the maximum stress rating of each of the two conversion units 3, as shown in FIG. 2B, a second connection unit 82 is connected between the sub negative input terminal 31b of the sub input port 31 of the first conversion unit 3 and the negative input terminal 21b of the input port 21. A first connection unit 81 is connected between the sub positive input terminal 31a of the sub input port 31 of the second conversion unit 3 and the positive input terminal 21a of the input port 21. Consequently, the sub input ports 31 of the two conversion units 3 are connected in parallel. In an embodiment, the first connection unit 81 and the second connection unit 82 are formed of copper blocks, circuit board traces or copper wires.

From above, when the input voltage received by the input port 21 of the power converter 1 of the present disclosure is greater than the maximum stress rating of any one of the two conversion units 3, the sub input ports 31 of the two conversion units 3 are connected in series. Namely, the power converter 1 determines the connection relationship of the conversion unit 3 according to the comparison result between the input voltage of the input port 21 and the maximum stress rating of the conversion unit 3. Consequently, each conversion unit 3 can operate properly. Moreover, the power converter 1 of the present disclosure can achieve both enhanced efficiency and enhanced input voltage range.

Please refer to FIG. 1 again. Each conversion unit 3 of the power converter 1 of this embodiment includes an input capacitor Cin, a first switch M1, a second switch M2, a resonant capacitor Cr, a resonant inductor Lr, a primary winding T1, a first secondary winding T2, a second secondary winding T3, a third switch M3 and a fourth switch M4. The input capacitor Cin is connected between the sub positive input terminal 31a and the sub negative input terminal 31b of the corresponding conversion unit 3. The first switch M1 and the second switch M2 are connected in series, and this series combination is connected in parallel with the input capacitor Cin. A connection point A is formed between the first switch M1 and the second switch M2. The resonant capacitor Cr, the resonant inductor Lr and the primary winding T1 are connected in series between the connection point A and one end of the input capacitor Cin. The first secondary winding T2 and the second secondary winding T3 are connected in series and coupled to the primary winding T1. A connection point between the first secondary winding T2 and the second secondary winding T3 is connected to the sub output port 32 and served as a center-tap structure. The third switch M3 is connected between the first secondary winding T2 and the sub output port 32. The fourth switch M4 is connected between the second secondary winding T3 and the sub output port 32. In this embodiment, the maximum stress rating of each conversion unit 3 is related to the withstand voltage and the topology of the switching elements (i.e., the first switch M1, the second switch M2, the third switch M3 and the fourth switch M4) within the corresponding conversion unit 3.

The power converter 1 of the present disclosure further includes an auxiliary power supply 4, a linear regulator 5, a first switching element 61 and a second switching element 62. The auxiliary power supply 4 is connected between the negative input terminal 21b of the input port 21 of the power converter 1 and a logic control circuit (not shown in figure) of the power converter 1 for suppling power to the logic control circuit. The linear regulator 5 is but not limited to a low dropout linear regulator. The linear regulator 5 is connected to the positive input terminal 21a of the input port 21 of the power converter 1 for performing voltage reduction when receiving the input voltage. The first switching element 61 is a diode and connected between the second conversion unit 3 and the auxiliary power supply 4. The anode of the first switching element 61 is connected to the input capacitor Cin of the corresponding conversion unit 3. The cathode of the first switching element 61 is connected to the auxiliary power supply 4. When the voltage across the input capacitor Cin of the second conversion unit 3 is greater than the output voltage of the linear regulator 5, the first switching element 61 is turned on. The first switching element 61 transfers the voltage of the input capacitor Cin of the second conversion unit 3 to the auxiliary power supply 4 to supply the auxiliary power supply 4. The second switching element 62 is a diode and connected between the linear regulator 5 and the auxiliary power supply 4. The anode of the second switching element 62 is connected to the linear regulator 5. The cathode of the second switching element 62 is connected to the auxiliary power supply 4. When the output voltage of the linear regulator 5 is greater than the voltage across the input capacitor Cin of the second conversion unit 3, the second switching element 62 is turned on. The second switching element 62 transfers the output voltage of the linear regulator 5 to the auxiliary power supply 4 to supply the auxiliary power supply 4.

In an embodiment, the first connection unit 81 and the second connection unit 82 may be formed of switching devices. The power converter 1 further includes a control module 9. The control module 9 is connected with the input port 21, the two conversion units 3, the first connection unit 81 and the second connection unit 82. When the input voltage of the input port 21 is greater than the maximum stress rating of any one of the two conversion units 3, the control module 9 controls the first connection unit 81 to be connected between the sub negative input terminal 31b of the sub input port 31 of the first conversion unit 3 and the sub positive input terminal 31a of the sub input port 31 of the second conversion unit 3. Consequently, the sub input ports 31 of the two conversion units 3 are connected in series. When the input voltage received by the input port 21 is less than the maximum stress rating of each of the two conversion units 3, the control module 9 controls the second connection unit 82 to be connected between the sub negative input terminal 31b of the sub input port 31 of the first conversion unit 3 and the negative input terminal 21b of the input port 21. The control module 9 also controls the first connection unit 81 to be connected between the sub positive input terminal 31a of the sub input port 31 of the second conversion unit 3 and the positive input terminal 21a of the input port 21. Consequently, the sub input ports 31 of the two conversion units 3 are connected in parallel.

In other embodiments, when the input voltage received by the input port 21 is less than the maximum stress rating of any one of the two conversion units 3, the sub negative input terminal 31b of the sub input port 31 of the first conversion unit 3 is connected to the sub positive input terminal 31a of the sub input port 31 of the second conversion unit 3. Consequently, the sub input ports 31 of the two conversion units 3 are connected in series.

As mentioned above, the present disclosure discloses a power converter. When the input voltage received by the input port of the power converter of the present disclosure is greater than the maximum stress rating of any one of the two conversion units, the sub input ports of the two conversion units are connected in series. Namely, the power converter determines the connection relationship of the conversion unit according to the comparison result between the input voltage of the input port and the maximum stress rating of the conversion unit. Consequently, each conversion unit can operate properly. Moreover, the power converter of the present disclosure can achieve both enhanced efficiency and enhanced input voltage range.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power converter comprising:
an input port and an output port, wherein the power converter is configured to receive an input voltage through the input port and output an output voltage through the output port; and
N conversion units, wherein N is an integer greater than 1, each of the N conversion units comprises a sub input port, a sub output port and a maximum stress rating, the sub input port of each of the N conversion units is connected with the input port to receive the input voltage, the sub output port of each of the N conversion units is connected with the output port, the maximum stress rating is a maximum stress tolerable by any component within the corresponding conversion unit, wherein when the input voltage of the input port is greater than the maximum stress rating of any one of the N conversion units, the sub input ports of the N conversion units are connected in series.

2. The power converter according to claim 1, wherein when the input voltage is less than the maximum stress rating of each of the N conversion units, the sub input ports of the N conversion units are connected in parallel.

3. The power converter according to claim 1, wherein the maximum stress rating of each of the N conversion units is related to a withstand voltage and a topology of switching elements within the corresponding conversion unit.

4. The power converter according to claim 1, wherein the power converter comprises at least N-1 connection units, the at least N-1 connection units are connected between the sub input ports of the N conversion units, and the at least N-1 connection units are formed of copper blocks, circuit board traces or copper wires.

5. The power converter according to claim 1, wherein the power converter comprises a control module and at least N-1 connection units, the control module is connected with the input port and the N conversion units, the control module controls the at least N-1 connection units to be connected between the sub input ports of the N conversion units, and the N-1 connection units are formed of switching devices.

6. The power converter according to claim 1, wherein each of the N conversion units comprises an input capacitor, a first switch, a second switch, a resonant capacitor, a resonant inductor, a primary winding, a first secondary winding, a second secondary winding, a third switch and a fourth switch, the input capacitor is connected with the sub input port, the first switch and the second switch are connected in series, and a series combination of the first switch and the second switch is connected in parallel with the input capacitor, a connection point is formed between the first switch and the second switch, the resonant capacitor, the resonant inductor and the primary winding are connected in series between the connection point and one end of the input capacitor, the first secondary winding and the second secondary winding are connected in series and coupled to the primary winding, the third switch is connected between the first secondary winding and the sub output port, and the fourth switch is connected between the second secondary winding and the sub output port.

7. The power converter according to claim 1, wherein the power converter further comprises:
an auxiliary power supply;
a linear regulator connected with the input port for performing voltage reduction when receiving the input voltage;
a first switching element connected between at least one of the N conversion units and the auxiliary power supply; and
a second switching element connected between the linear regulator and the auxiliary power supply, wherein an output port of the first switching element and an output port of the second switching element are connected with each other to connect with the auxiliary power supply.

8. The power converter according to claim 1, wherein each of the N conversion units is a resonant converter, a full-bridge circuit or a flyback circuit.
